(19) United States
(12) Patent Application Publication
(10) Pub. No.: US 2003/0078887 A1
(43) Pub. Date: Apr. 24, 2003

(54) Electronic settling method and system and electronic settling terminal

(76) Inventors: Ichiro Suzuki, Tokyo (JP); Etsuo Abe, Tokyo (JP); Yoshihiro Iwashiro, Tokyo (JP); Hirokazu Minatoya, Tokyo (JP); Yuji Katayama, Tokyo (JP)

Correspondence Address: BROWDY AND NEIMARK, P.L.L.C., 624 NINTH STREET, NW, SUITE 300, WASHINGTON, DC, 20001-5303, US

(21) Appl. No.: 10/275,387

(22) PCT Filed: Apr. 19, 2001
(86) PCT No.: PCT/JP01/03355

(30) Foreign Application Priority Data
Mar. 5, 2001 (JP) 2001-059747

(51) Int. Cl. G06F 17/60

(52) U.S. Cl. 705/41

(57) ABSTRACT

An electronic settling system in which illegal use involving a missing IC card is prevented, characterized by comprising an IC card for storing settlement data for settling a charge with a financial institution and payment data corresponding to charges for services or on merchandise, wherein the settlement data is used in effecting a settlement of a charge with a financial institution; an electronic settling terminal carried by a user of the IC card; and, a charge-settling computer for effecting a settlement of a charge on the basis of the data stored in the IC card. The electronic settling system is characterized by comprising: means for enabling the user to set the electronic settling terminal into a usable state; means for retrieving both payment data and settlement data from the electronic settling terminal and writing both the data on the IC card; settlement means for effecting a settlement online by retrieving the data from the IC card through the charge-settling computer; and, means for erasing the data of the IC card after completion of the online settlement of the charge.

### FIELD OF THE INVENTION

The present invention relates to an electronic settling method and system, and more particularly an electronic settling method and system and electronic settling terminal, wherein: both the electronic settling terminal and an IC card are used; in making a payment, the IC card is used by writing both payment data and settlement data on the IC card to make such a payment.

### BACKGROUND OF THE INVENTION

A conventional IC card for making a payment varies in type, for example such as an IC card of a prepaid type and a credit card of a prepaid type. In any case, when a user loses his or her IC card, there is a fear that someone or a person who gets possession of the user's IC card uses the IC card illegally. This is because all pieces of information necessary to effect a settlement of charges are stored on the IC card all the time in its validity period.

Since the conventional IC card for making a payment of a charge suffers from the above illegal use problem, it is an object of the present invention to provide an electronic settling method and system and electronic settling terminal, all of which is free from a fear from illegal use of a user's IC card when the user loses his or her IC card, whereby a heavy security against such illegal use of the IC card is provided by the present invention.

### DISCLOSURE OF THE INVENTION

The above object of the present invention is accomplished by providing an electronic settling method of the present invention, which method is characterized by comprising the steps of: setting an electronic settling terminal into a usable state, the electronic settling terminal being carried by the user; retrieving payment data from an IC card; displaying the payment data in content when the payment data exists; inputting the payment data by a user when the payment data does not exist, writing settlement data and the payment data on an IC card; retrieving the payment data and the settlement data by means of a charge-settling computer, wherein both the payment data and the settlement data have been written on the IC card; effecting a settlement of the retrieved data online with respect to a financial institution; and, erasing information contained in the IC card after completion of the online settlement.

Further, the above object of the present invention is also accomplished by providing an electronic settling system of the present invention, which system is constructed of: an IC card for storing therein both settlement data and payment data corresponding to charges for services or on merchandise, wherein the settlement data is used in effecting a settlement of the charges with a financial institution; an electronic settling terminal carried by a user of the IC card; and, a charge-settling computer for effecting a settlement of the charges on the basis of the data stored in the IC card, the electronic settling system being characterized by comprising: means for enabling the user to set the electronic settling terminal into a usable state; means for retrieving both payment data and settlement data from the electronic settling terminal and writing both the data on the IC card; settlement means for effecting a settlement of the charges online by retrieving the data from the IC card through the charge-settling computer; and, means for erasing the data of the IC card after completion of the online settlement.

The means for setting the electronic settling terminal into the usable state is realized by collating a personal identification number having stored in the electronic settling terminal with a series of numbers inputted by a person. On the other hand, the personal identification number is constructed of a four-digit number and one character or symbol.

Still Further, the above object of the present invention is also accomplished by providing an electronic settling terminal of the present invention, which terminal is an apparatus for inputting, on an IC card, settlement data for effecting a settlement of charges with a financial institution, and for inputting, an said IC card, payment data of the charges for services or on merchandise, the terminal being characterized in that: a predetermined personal identification number is stored in the terminal together with a computer program; and, the IC card receives an input only when a series of numbers inputted by a person coincides with the predetermined personal identification number having been stored in the terminal.

### BRIEF DESCRIPTION OF THE DRAWING

FIG. 1 is a view illustrating an operational system of the electronic settling system of the present invention.

FIG. 2 is a view illustrating, in appearance, a terminal used in the electronic settling system of the present invention.

FIG. 3 is a view illustrating an arrangement in hardware of the electronic settling system of the present invention.

FIG. 4 is a flow chart illustrating the means of the present invention for paying the charge.

FIG. 5 is a flowchart illustrating the means of the present invention for effecting the settlement of the charge.

### BEST MODE FOR CARRYING OUT THE INVENTION

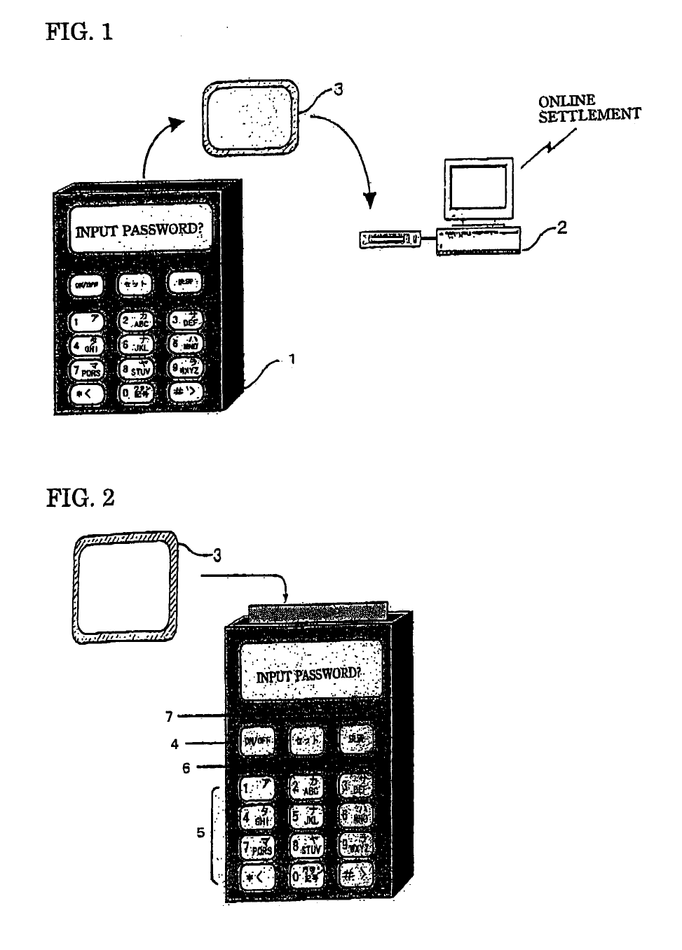

Hereinbelow, with reference to the accompanying drawings, embodiments of the present invention will be described. FIG. 1 is a view illustrating, in construction, an operational system of an electronic settling system of the present invention for carrying out an electronic settling method of the present invention. The present system shown therein is constructed of an electronic settling terminal 1, a charge-settling computer 2 for settling a charge and an IC card 3.

The electronic settling terminal 1 is used in paying a charge by writing both payment data and settlement data on the IC card 3.

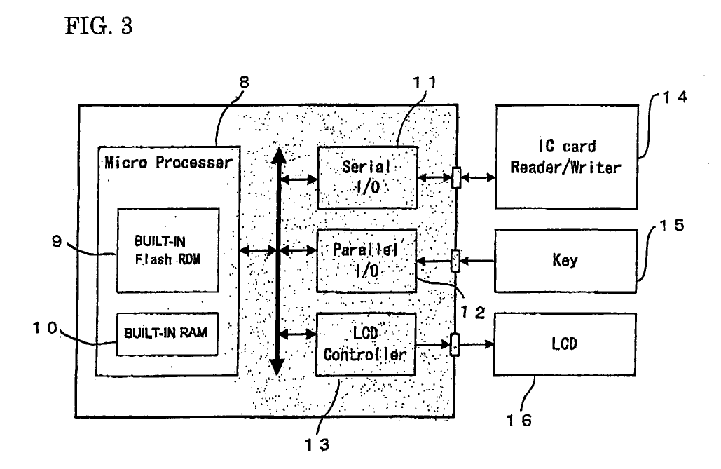

The IC card 3 is one of media for transferring necessary information from the electronic setting terminal 1 to the charge-settling computer 2. On the other hand, the IC card 3 stores thereon no data in an initial stage, which data should be settled. In other words, the IC card becomes available in settling the charge only when payment data and settlement data are stored on the IC card by the electronic settling terminal or by the charge-settling computer 2. FIG. 2 is a schematic view of the electronic settling terminal 1, a hardware arrangement of which is shown in FIG. 3.

A keyboard 5 of the electronic settling terminal 1 comprises: a power switch button 4 for energizing the electronic settling terminal 1; a character-type key 5 for inputting a personal identification number, the sum of a payment and the like; an inputted character data determination button 6 for determining the inputted personal identification number and the inputted sum of the payment; and, a settlement determination button 7 for writing both the settlement data and the payment data on the IC card.

Further, as shown in FIG. 3, the electronic settling terminal 1 is constructed of: a microprocessor 8 for performing a task inputted through the electronic settling terminal 1; a flash memory 9 for storing an execution program (which is executable in the microprocessor 8) and a personal identification number; a RAM 10 serving as a working memory for the microprocessor 8; a serial interface 11 constructed of an interface circuit for controlling a card reader 14; a parallel interface 12 constructed of an interface circuit for receiving an input signal issued from the keyboard 15 of the electronic settling terminal 1; a liquid crystal controller 13 constructed of an interface circuit for controlling in display a liquid crystal display unit 16; the card reader 14 constructed of a unit for writing and retrieving data on and from the IC card 3; and, the liquid crystal display unit 16 constructed of a liquid crystal display panel forming a control screen of the electronic settling terminal 1.

In construction, the charge-settling computer 2 is a computer for effecting a settlement of a charge online with a financial institution by retrieving the information from the IC card 3, wherein the information comprises the payment data and the settlement data each having been written on the IC card by means of the electronic settling terminal 1.

In the present system, first of all, in paying the charge, both the payment data and the settlement data are written on the IC card 3 through the electronic settling terminal 1 by the user. The payment data comprises data of the sum of payment, data of payment method and the like data. On the other hand, the settlement data comprises data of each individual person, data of a financial institution for handling the payment and data necessary for settlement of the charge with respect to the financial institution. In operation, when the IC card 13 is set in the charge-settling computer 2 in settling the charge, a necessary online settlement procedure is performed. After proper completion of this settlement procedure, the data written on the IC card 3 is automatically deleted from the IC card 3

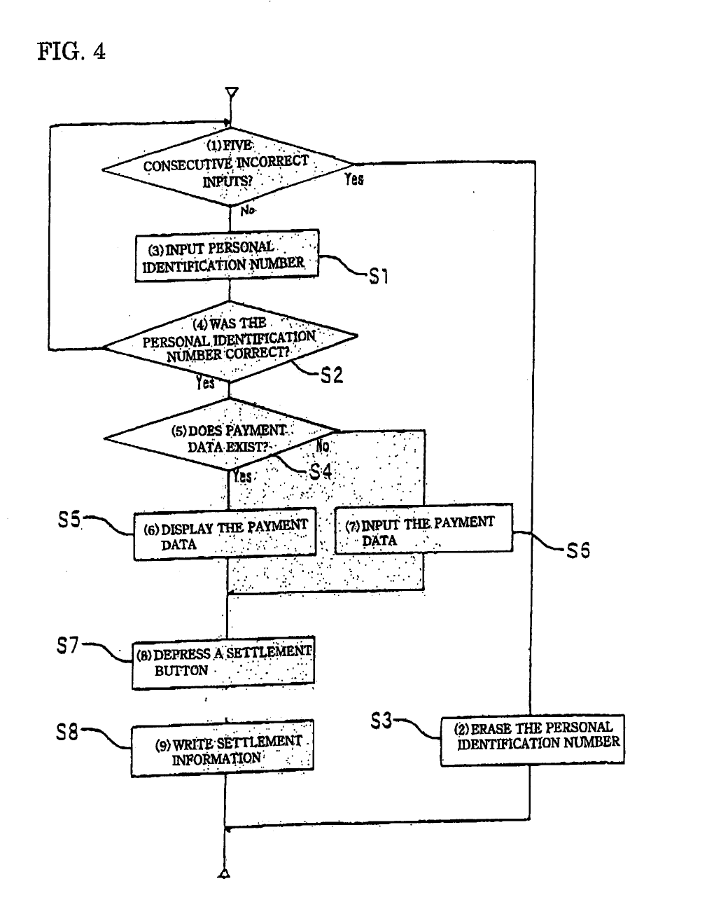

Next, a charge payment procedure will be described in detail. A flowchart, which illustrates the charge payment procedure for retrieving the data from the electronic settling terminal 1 and writing the same data on the IC card when the charge is paid online, is shown in FIG. 4.

As shown in FIG. 4, the user inputs his or her personal identification number, which enables the user to use the electronic settling terminal 1 (in the step S1 of the flowchart: an input step of the personal identification number). In general, a four-digit number is used as the personal identification number. In this case, since the user's birthday or telephone number is very often used as the personal identification number, it is not so difficult for those skilled in the art to find out the user's personal identification number. Due to this, in the present invention, the personal identification number is constructed of a five-digit number. Of such a five-digit number, the first one or the last one of the figures thereof is constructed of any one of a Japanese character called “Katakana”, special letters or symbols such as “※”, “#” and like symbols.

After collating a five-digit number inputted by someone or person with the user's personal identification number, the electronic settling terminal 1 becomes available only when the five-digit number inputted by the person coincides with the user's personal identification number which has been already stored in the flash memory 9 of the electronic settling terminal 1 together with the program. In the case where the five-digit number inputted by the person is not correct, it is necessary for the person to repeatedly input another five-digit number. In the case where the thus inputted five-digit number is correct, the following steps (subsequent to the step 4 in which the presence of payment data is checked) are conducted (wherein, in the step 2, it is judged as to whether or not the personal identification number is correct).

In the case where five consecutive errors has occurred in inputting the personal identification number, the personal identification number having been stored in the electronic settling terminal 1 is deleted from the terminal 1 to disable the terminal 1 so that illegal use of the terminal 1 is prevented (in the step 3: “delete the personal identification number”).

When the correct personal identification number is inputted in the electronic settling terminal 1, the terminal 1 retrieves the payment data having been stored in the terminal 1 from the terminal 1 (in the step 4, it is determined whether or not the payment data exists). In this step 4, when the payment data has been previously written and therefore stored in the terminal 1 by the charge-settling computer 2, the payment data is displayed in content on the liquid crystal display unit 16 (the step 5: “display the payment data”).

When the payment data is not stored in the IC card, the electronic settling terminal 1 waits for the user's inputting operation of the payment data to urge the user to input the payment data by displaying a request that the user should input the payment data using the keyboard 15 (the step 6: “input the payment data”). At this stage, it is necessary for the user to confirm the payment data in content. After his or her confirmation of the payment data, when the user depresses a settlement determination button 7 (the step 7: “depress a settlement button”), both the settlement data and the payment data are written on the IC card (the step 8: “write the settlement data”).

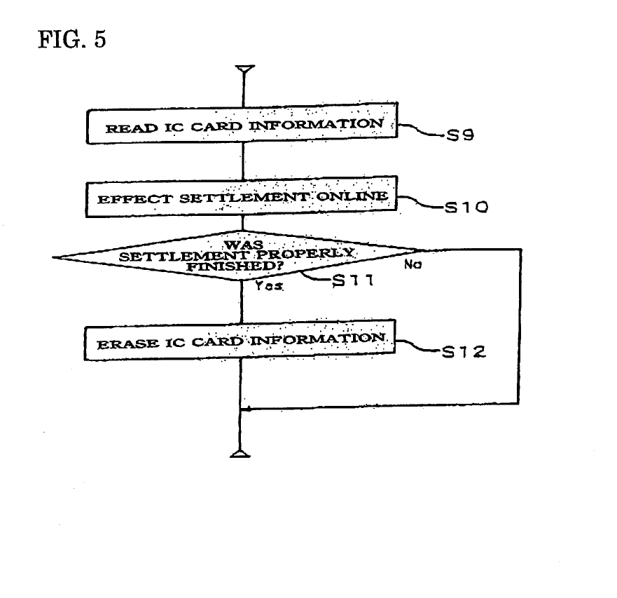

Next, a settlement procedure will be described. By using the charge-settling computer 2, the data written on the IC card 3 is retrieved to perform a settlement of the charge online, as shown in a flowchart of FIG. 5.

The payment data having been written on the IC card 3 using the electronic settling terminal 1 is now retrieved from the IC card 3 so that the thus retrieved payment data is displayed (the step 9: “read the data of the IC card”). By using the payment data and the settlement data both retrieved from the IC card 3, the settlement of the charge is effected online with a financial institution (the step 10: “effect the settlement online”).

After proper completion of the settlement of the charge online, the information stored on the IC card is deleted. When deletion of the information is not properly finished, the program following the flowchart leads directly to a stop step of the program (the step 11: “was the settlement properly finished?”).

In coincident with the finish of the settlement of the charge, the payment data and the settlement data both stored in the IC card 3 are deleted from the IC card 3 (the step 12: “erase the information stored in the IC card”). As described above, the payment data and the settlement data both stored in the IC card 3 have been retrieved from the electronic settling terminal 1 in paying the charge, and are now deleted in coincident of the settlement of the charge. Consequently, the ordinary IC card 3 is not important, and becomes therefore meaningless, which makes it possible for the user to prevent his or her lost IC card 3 from being illegally used.

Industrial Applicability

As described above, in the electronic settling method and system both according to the present invention, the information necessary for effecting the settlement of the charge is stored in the IC card for a very short period of time only required to pay the charge. Due to this, when the user loses his or her IC card in the electronic settling method and system of the present invention, there is no fear that the thus lost IC card is illegally used so as to damage the user's property.

Further, in the case where the electronic settling terminal 1 of the present invention is lost, any person other than the user can't use the electronic settling terminal 1 because of the presence of the user's personal identification number. Due to this, the electronic settling terminal of the present invention is excellent in security even when the user's IC card is lost or stolen.

Further, in the electronic settling terminal of the present invention: the number inputted by someone or person is collated with the user's personal identification number having been stored together with the program in a built-in flash memory of the terminal; and, only when the number inputted by someone or person coincides with the user's personal identification number, the electronic settling terminal of the present invention becomes available. Due to this, it is possible to prevent the user's personal identification number from being stolen from the electronic settling terminal even when the electronic settling terminal is disassembled

1. An electronic settling method characterized by comprising the steps of: setting an electronic settling terminal into a usable state, said electronic settling terminal being carried by said user; retrieving payment data from an IC card; displaying said payment data in content when said payment data exists; inputting said payment data by a user when said payment data does not exist; writing settlement data and said payment data on an IC card; retrieving said payment data and said settlement data by means of a charge-settling computer, wherein both said payment data and said settlement data have been written on said IC card; effecting a settlement of said retrieved data online with respect to a financial institution; and, erasing information contained in said IC card after completion of said online settlement.

2. The electronic settling method as set forth in claim 1, wherein said step of setting said electronic settling terminal into said usable state is carried out by collating a personal identification number with a series of numbers inputted by a person, wherein said personal identification number has been stored in said electronic settling terminal.

3. The electronic settling method as set forth in claim 1, wherein said personal identification number is constructed of a four-digit number and one character or symbol.

4. The electronic settling method as set forth in claim 1, further comprising the step of disabling said electronic settling terminal when the number of consecutive errors in inputting said personal identification number reaches a predetermined number.

5. An electronic settling system constructed of: an IC card for storing therein both settlement data and payment data corresponding to charges for services or on merchandise, wherein said settlement data is used in effecting a settlement with a financial institution; an electronic settling terminal carried by a user of said IC card; and, a charge-settling computer for effecting a settlement on the basis of said data stored in said IC card, the electronic settling system being characterized by comprising: means for enabling the user to set said electronic settling terminal into a usable state; means for retrieving both payment data and settlement data from said electronic settling terminal and writing both said data on said IC card; settlement means for effecting a settlement online by retrieving said data from said IC card through said charge-settling computer; and, means for erasing said data or said IC card after completion of said online settlement.

6. The electronic settling system as set forth in claim 5, wherein said means for setting said electronic settling terminal into said usable state is realized by collating a personal identification number having stored in said electronic settling terminal with a series of numbers inputted by a person.

7. The electronic settling system as set forth in claim 5, wherein said personal identification number is constructed of a four-digit number and one character or symbol.

8. The electronic settling system as set forth in claim 5, further comprising means for disabling said electronic settling terminal when the number of consecutive errors in inputting said personal identification number reaches a predetermined number.

9. A terminal for an electronic setting system in an apparatus for inputting, on an IC card, settlement data for effecting a settlement with a financial institution and payment data of a charge for services or on merchandise, said terminal for said electronic settling system being characterized in that: a predetermined personal identification number is stored in the said terminal together with a computer program; and, said IC card receives an input only when a series of numbers inputted by a person coincides with said predetermined personal identification number having been stored in said terminal.
